(19) United States
(12) Patent Application Publication
(10) Pub. No.: US 2014/0295725 A1
(43) Pub. Date: Oct. 2, 2014

(54) COMPOSITE PROFILE AND METHOD FOR MANUFACTURING A COMPOSITE PROFILE

(71) Applicants: BAYER INTELLECTUAL PROPERTY GmbH, Monheim (DE); BAYER INTERNATIONAL SA, Fribourg (CH)

(72) Inventors: Dirk Passmann, Oberhausen (DE); Kim Klausen, Odense N. (DK)

(21) Appl. No.: 14/350,735

(22) PCT Filed: Oct. 8, 2012
(86) PCT No.: PCT/EP2012/069854

§ 371 Date: Apr. 9, 2014

(30) Foreign Application Priority Data
Oct. 11, 2011 (EP) 11184631.7

(51) Int. Cl. B32B 5/24; B32B 37/14; B29C 70/78; B32B 5/02

(52) U.S. Cl. CPC B32B 5/245; B32B 5/022; B32B 5/024; B32B 37/144; B29C 70/78; B32B 2603/00
USPC 442/221; 428/304.4; 442/370; 156/293; 264/46.6

(57) ABSTRACT

A composite profile comprises: a foam core (1) with opposing frontal faces (2) and a plurality of side faces (3); and a reinforcement fabric (4) which is at least partially in direct contact with at least two adjacent side faces (3). The reinforcement fabric (4) is a woven textile or an at least bidirectionally oriented non-woven textile; the foam core (1) does not or not completely penetrate into the reinforcement fabric (4); and at least on one side face (3) the foam core (1) is exposed. A method of manufacturing comprises the steps of: (I) providing a reinforcement fabric (4), the reinforcement fabric (4) being provided in such a shape as to define at least one upwardly open cavity (1′) adapted to receive a foam (4); and (H) providing a solid or spreadable foam (1) into the at least one cavity (1′) of the reinforcement fabric (4).

The present invention relates to a composite profile, comprising at least one of: a foam core with opposing frontal faces and a plurality of side faces; and a reinforcement fabric which is at least partially in direct contact with at least two adjacent side faces. The invention also relates to a method for manufacturing such a composite profile.

The importance of wind energy is increasing steadily. This leads to an intense research into and further development of wind energy systems, especially into the rotor blades of such wind energy systems. A key consideration is the quality of the rotor blades and their economical production. Currently known rotor blades for wind energy systems are made from fiber reinforced materials based on resins as a matrix material, for example polyester resins (UP), vinyl ester resins (VE) or epoxy resins (EP). The production of the rotor blades is essentially the one-piece assembly of a lower side and an upper side which are placed on top of each other and bonded together. Stiffeners or belts bay be included in the interior for added stability.

In this production of the rotor blade halves fiber reinforced composites are first prepared which need to harden. This hardening process is time-consuming and detrimental for a rapid overall production. Generally the rotor blades for wind energy systems using the aforementioned resins are made using techniques such as hand lamination, hand lamination with prepreg technology, wrapping or resin-assisted vacuum infusion.

U.S. Pat. No. 3,544,417 is directed towards a cellular foam core assembly, the combination of: said assembly including at least one cellular foam core structure; each cellular foam core structure of said assembly including a series of generally parallel, longitudinally extending and generally transversely aligned foam cores, each core being preformed of a closed cell plastic foam material of a defined transverse cross section with all surfaces in transverse cross section being substantially flat, each core in transverse cross section having at least a lower base side and generally oppositely transversely, facing sides; each cellular foam core structure of said assembly including a primary base layer of fabric extending substantially continuously transversely and longitudinally along and fully contacting and covering said foam core lower base side, said primary base layer abutting said foam core lower base side and extending transversely between said foam cores substantially free of upward projection between said foam cores; each cellular foam core structure of said assembly including a primary covering layer of fabric extending substantially continuously upwardly over and downwardly transversely between said foam cores, said primary covering layer abutting all of said foam core oppositely transversely facing sides free of abutment with said foam core lower base slides and contacting said primary base layer at transverse extremities of each of said foam cores at said primary base layer completing said foam core longitudinal and transverse covering; each cellular foam core structure of said assembly including a generally longitudinally extending line of stitching at each of said foam core transverse extremities securing said primary base and covering layers together at said primary base layer and transversely between each transversely adjacent set of said foam cores of said each cellular foam core structure; said assembly including a lower secondary covering layer of fabric extending generally continuously transversely and longitudinally along fully contacting and covering said primary base layer of said at least one cellular foam core structure of said assembly, said lower secondary covering layer being free of upward projection transversely between any foam cores of said assembly; said assembly including an upper secondary covering layer of fabric extending generally continuously transversely being resin bonded thereto, said upper secondary cover and longitudinally along said assembly overlying and upwardly covering those parts of said primary covering layer of said at least one cellular foam core structure of said assembly at upper extremities of said foam cores thereof, said upper secondary covering layer being free of downward projection transversely between any foam cores of said assembly; said assembly including cellular foam core structure cores of said assembly being closely transversely adjacent one to the next transversely adjacent core with the primary covering layer of each core abutting the primary covering layer of that core's next transversely adjacent core; and cured resin covering, impregnating and rigidifying all of said base and covering layers of said assembly throughout said layers including said stitching, said cured resin bonding between said layers at said stitching and at all other areas of abutment between said layers rigidifying and bonding said assembly.

Reinforced foam cores are disclosed in U.S. Pat. No. 5,589,243. This patent relates to rigid foam boards and alternating absorptive fibrous web sheets which are adhered to form core panels or billets. Porosity is maintained in the webs for forming integral structural ties by absorbing resin applied to overlying sandwich panel skins. Beveled foam recesses adjacent web edge portions form structural resin fillets, and protruding edge portions form expanded connections to the skins Core panels oriented with their webs crossing are layered with web sheets to form enhanced panels. Boards or core panels and web sheets arranged in inclined stacks form second core panels having webs intersecting panel edges or faces at acute angles. Boards of alternating different physical properties and web sheets are bonded to form reinforced panels having differing interior and exterior densities. Compressible foam panels are used in place of or with web sheets to make bendable core panels. Foam between web edge portions is recessed for bonding a settable material to the edge portions.

U.S. 5,429,066 describes a composite structure and method of making the composite structure. A reinforcing fabric such as fiberglass is mechanically attached, for example, by stitching to a non-woven polyester fabric. The attached fabrics are placed in a mold with the non-woven fabric facing the inside of the mold. A self-expanding, self-curing foam is filled into the mold in an amount sufficient so that upon expansion in the closed mold, the foam penetrates into the interstices of the non-woven fabric which upon curing forms a bond therewith. The resulting structure can be used in a number of applications wherein the reinforcing fabric is later impregnated, for example, with a resin, and allowed to cure. Typical use of such a structure is as a stringer in fiberglass boat construction.

U.S. Pat. No. 5,908,591 is concerned with a method for making a composite structure, comprising the steps of: arranging a fabric layer in a configuration constrained against outward movement and defining a cavity between opposing surfaces of the fabric layer; dispensing a predetermined amount of a self-expanding, self-curable, uncured structural foam into the cavity, the foam expanding and curing in the cavity at a molding pressure determined by the predetermined amount of the foam and thereby attaching itself to the fabric layer to form the composite structure, the molding pressure causing the expanding foam to substantially fill only interstices of an inner portion of the fabric layer, without substantially penetrating an outer portion of the fabric layer; and, freeing the cured composite structure from the constraint of the arranging step, the outer portion of the fabric layer of the composite structure being thereafter substantially completely saturable with a curable material for lamination to another structure in a subsequent processing step. The method can further comprise the step of laminating the cured composite structure to another composite structure by saturating the outer portion of the fabric layer of the cured composite structure with a curable resin.

US 2002/0178992 A1 relates to a conformable composite reinforcing member which includes a cavity formed at least in part from a fabric layer and at least a first foam core and at least a second foam core positioned within the cavity. The second foam core has a relatively higher rigidity than the first foam core. The first foam core is preferably made from an open cell or flexible foam and the second foam core is preferably made from a rigid open cell foam.

In vacuum-assisted resin infusion processes a (glass) fiber reinforced layer is first placed into a mold. Then a so-called distance layer is placed onto this first fiber reinforced layer. This distance layer is usually a balsa wood, polyvinyl chloride (PVC) foam or polyurethane (PUR) foam layer. Then a second (glass) fiber reinforced layer is placed into the mold in an analog way as the first layer. The resin can enter the voids between the fiber reinforced layers after applying a vacuum. It is also possible that the elements of the distance layer also incorporate a (glass) fiber material. The production of these distance elements may be via a two-step wrapping process in which pre-fabricated foamed profiles are equipped with a (glass) fiber layer.

For example, WO 2009/102414 A1 discloses a fiber reinforced core panel having a first side and an opposing second side. The core panel contains a series of adjacent low density strips having at least three faces. The major face of each strip is disposed within the first or second side of the core panel and the major face of each strip is disposed within an opposite face of the core panel than the major face of the adjacent strips. The core panel also contains a continuous fibrous reinforcement sheet which is threaded through the low density strips such that the fibrous reinforcement sheet is disposed between adjacent strips and adjacent to the major faces of the low density strips. The reinforcement sheet forms at least about sixty five percent of the surface area of the first side and at least about sixty five percent of the surface area of the second side of the core panel.

EP 1 310 351 A1 discloses a method for making a windmill blade whereby problems with glue joints and with exposure of the workers to environmentally hazardous substances are avoided. This is effected by making the windmill blade in a closed mould with a mould core inside mould parts for formation of a mould cavity, in which fiber material and core material are placed. After applying vacuum to the mould cavity, matrix material is injected via a filling pipe, which is placed at a downwardly oriented side edge of the blade during the filling. Hereby is established a flow front which is used for indicating complete filling when this reaches the trailing edge of the blade and penetrates out through overflow apertures.

The complexity of these processes is disadvantageous as it leads to higher production costs or a limited potential for automatic production of the distance elements.

The present invention has the object of at least partially overcoming the drawbacks in the art. In particular, the present invention has the object of providing a simplified distance element useful for the production of rotor blades or other composite articles and of providing a method for the production of such distance elements.

According to the invention this object is achieved by a composite profile, comprising at least one of:
a foam core with opposing frontal faces and a plurality of side faces; and
a reinforcement fabric which is at least partially in direct contact with at least two adjacent side faces;
   wherein the reinforcement fabric is a woven textile or an at least bidirectionally oriented non-woven textile; the foam core does not or not completely penetrate into the reinforcement fabric; and at least on one side face of the composite profile the foam core is exposed.

It is understood that the term “comprising at least one of” in the present invention has the meaning of “comprising at least one each of”. It is further understood that the reinforcement fabric is at least partially in direct contact with at least two adjacent side faces of said foam core. Due to the fact that the foam core does not or not completely penetrate into the reinforcement fabric, it is achieved that the voids or interstices in the fabric are not sealed by the foam. Ideally there is only a superficial contact which does not extend into the depth of the fabric.

The composite profile according to the invention is especially suited as a distance element in objects into which resin is infused by pressure or vacuum methods. Because the foam core does not or not completely penetrate into the reinforcement fabric the voids of this fabric can be used to apply vacuum or pressure. Then the resin can spread along the reinforcement fabric, leading to an internal bonding within the object. Examples for such objects include rotor blades for wind energy systems and floors for reefer containers and trailers.

Another aspect of the present invention is a method of manufacturing a composite profile according to the invention, comprising the steps of:
(I) providing a reinforcement fabric, the reinforcement fabric being provided in such a shape as to define at least one upwardly open cavity adapted to receive a foam and wherein at least two adjacent sides of the cavity are formed by the reinforcement fabric; and
(II) providing a solid or spreadable foam into the at least one cavity of the reinforcement fabric, wherein the foam does not or not completely penetrate into the reinforcement fabric.

The method according to the invention easily avoids the disadvantages of a two-step wrapping process. Especially in the case of a direct foaming into the reinforcement fabric the method is suited for an automated, continuous production. Due to the fact that the foam does not or not completely penetrate into the reinforcement fabric, it is achieved that the voids or interstices in the fabric are not sealed by the foam. Ideally there is only a superficial contact which does not extend into the depth of the fabric.

The present invention will be further described with reference to the following embodiments and figures without wishing to be limited by them. The embodiments may be combined freely unless the context clearly indicates otherwise.

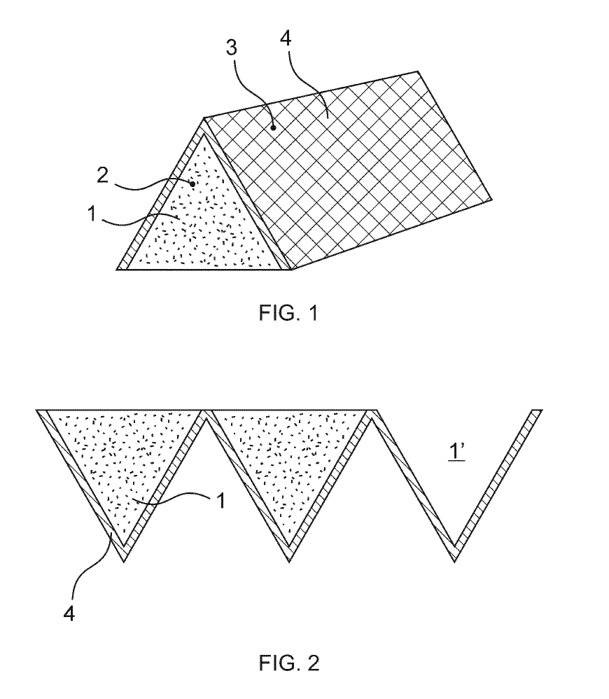

FIG. 1 shows a composite profile according to the invention

FIG. 2 shows another composite profile according to the invention

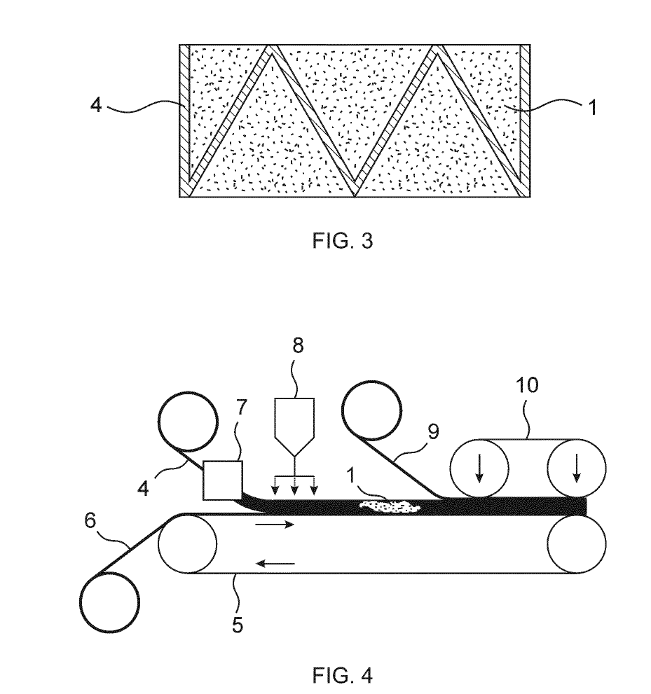

FIG. 3 shows another composite profile according to the invention

FIG. 4 shows a method according to the invention

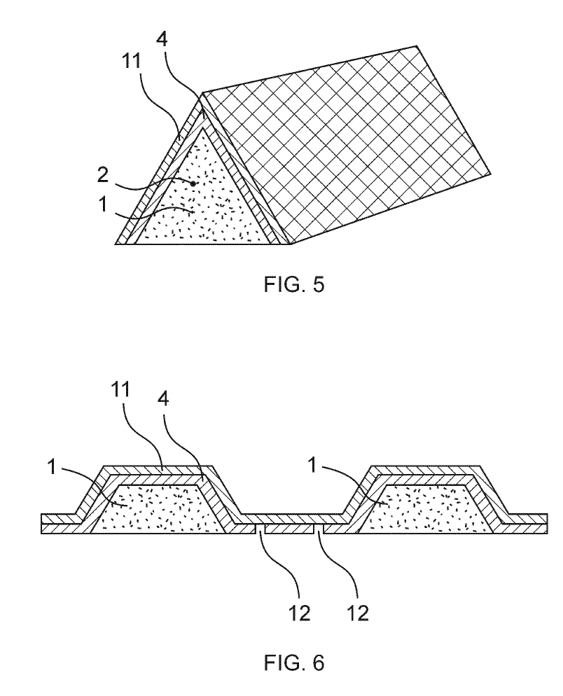

FIG. 5 shows another composite profile according to the invention

FIG. 6 shows another composite profile according to the invention

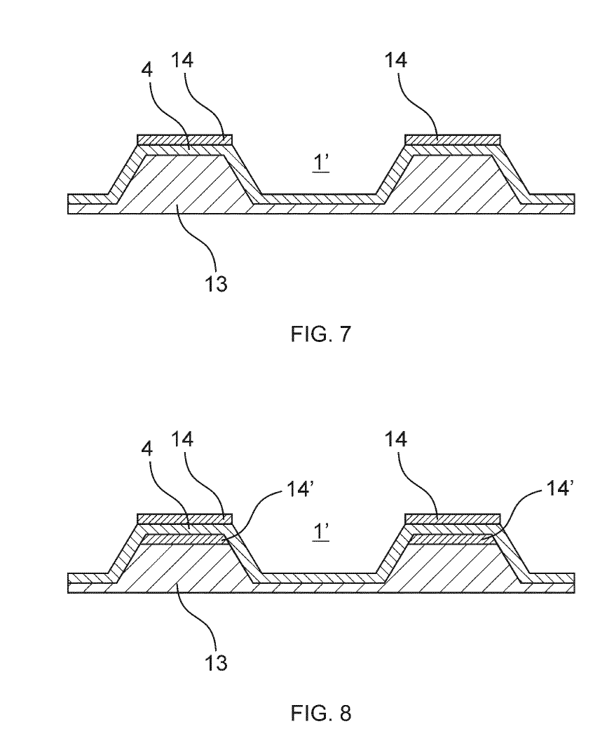

FIG. 7 shows a step during a method according to the invention

FIG. 8 shows another step during a method according to the invention

The composite profile according to the invention may have an at least triangular cross-section in its longitudinal direction. With this cross-section of the profile curved bodies may be constructed without having undesired voids (as in the case with balsa wood profiles) into which additional resin, adding to the total weight, may accumulate.

Such a composite profile according to the invention is schematically depicted in FIG. 1. The foam core 1 has a triangular cross-section in its longitudinal direction. Depending on the intended use of the profile cross-sections with more corners, such as four, five or six corners, are within the scope of the invention. It is also within the scope of the present invention that the triangles, rectangles, etc. display rounded corners.

In accordance with viewing the composite profile as prism-shaped FIG. 1 shows further geometrical descriptors for further clarification: a frontal face 2 to which an opposing frontal face on the other side corresponds (not shown) and a side face 3 to which two further side faces (not shown) correspond.

Suitable materials for the foam include duroplastic polymers. The raw density of the foam core 1 (DIN EN 1602) may preferably be in a range of 30 kg/m³ to 60 kg m³. Two adjacent side faces 3 are in direct contact with the reinforcement fabric 4. In the case of a triangular cross-section all side faces are adjacent to each other. With a higher number of corners present this is not automatically the case which is why the present invention calls for at least two adjacent sides. This is easily envisioned with reference to the production method as will be described further below.

By reinforcement fabric is meant a fabric which when added to a composite material enhances the structural properties of the material. Materials suitable for the reinforcement fabric 4 include sized or unsized fibers such as glass fibers, carbon fibers, steel fibers, iron fibers, natural fibers, aramid fibers, polyethylene fibers, basalt fibers or carbon nanotubes (CNTs). The use of continuous fibers is preferred.

According to the invention it is provided that the reinforcement fabric 4 is a woven textile or an at least bidirectionally oriented non-woven textile. It is possible that the reinforcement fabric 4 comprises more than one fiber layer. Then the fiber orientation may also vary from layer to layer. For example, multidirectional fiber layers are contemplated in which unidirectional or woven layers are stacked upon each other.

It is preferred that the reinforcement fabric 4 is a biaxial non-woven fabric with at least a portion of the fibers oriented in an angle of 40° to 50° with respect to the longitudinal axis of the foam core 1.

The bonding between foam core 1 and the reinforcement fabric 4 should, as it is customary for fiber reinforced composites, be able to transfer mechanical forces acting upon the composite.

Therefore a substance-to-substance connection is preferred. Using appropriate caution, an adhesive may be employed.

With respect to the contact between the foam core 1 and the reinforcement fabric 4 it is provided that the foam core does not or not completely penetrate into the reinforcement fabric 4. By this it is achieved that the voids or interstices in the fabric are not sealed by the foam. Ideally there is only a superficial contact which does not extend into the depth of the fabric.

In the present invention on at least one side face 3 of the composite profile the foam core 1 is exposed. The term “exposed” is to be understood in such a manner that in the profile the side face is or side faces are not permanently covered, especially not covered by a reinforcement fabric or other woven or non-woven textiles. For example, in the downward oriented side face of the composite profile as depicted in FIG. 1 is the foam core 1 is exposed.

In one embodiment of the composite profile according to the invention the foam core 1 has a triangular cross-section and a ratio of length to width of at least 5:1, preferably 20:1. It is also preferred that the triangle defined by the cross-section is an equal-sided or equilateral triangle.

In another embodiment of the composite profile according to the invention the foam core 1 comprises a polyurethane foam (PU foam), an epoxy resin foam (EP foam), a polyester resin foam (in particular an unsaturated polyester resin foam; UP foam), an expanded polystyrene foam (EPS foam) and/or an expanded polypropylene foam (EPP foam). Other expanded polyolefin foams or further thermoplastic or duroplastic foams are also possible.

Polyurethane foams are generally known and can be obtained by the reaction of polyisocyanates with compounds having at least two NCO-reactive hydrogen atoms such as polyols, polythiols and/or polyamines in the presence of chemical and/or physical blowing agents or by mechanical frothing.

The polyol component useful herein is composed of one or more polyol(s) with a molecular weight of from about 60 to 7000 g/mol and contains 2 to 8 reactive groups. Such polyols are generally known in the art and include polyethers, polyether amines, polyesters, polyester amides and polycarbonates. Polyether and/or polyester polyols are generally preferred.

Polyethers are known in the art and are generally prepared by alkylene oxide adducts of diols, triols and higher functionality polyols and/or polyamines Such diols, triols and higher functionality polyols include, as none limiting examples, ethylene glycol, propylene glycol, ethylenediamine, diethylene glycol, triethylene glycol, dipropylene glycol, diethylenetriamine, 1,3-butanediol, 1,4-butanediol, neopentyl glycol, 1,6-hexanediol, toluenediamine, hydroquinone bis(2-hydroxyethyl)ether, diphenylmethanediamine, glycerol, trimethylol propane, diethylenetriamine, triethanolamine, 1,2,4-butanetriol, pentaerythritol, diglycerol, sugars, and other low molecular weight polyols. Suitable alkylene oxide include, as none limiting examples, ethylene oxide, 1,2-propylene oxide, or 1,2-butylene, or mixtures thereof. Other polyethers useful herein are known in the art as polyoxymethylene (POM), polytetrahydrofuran (PTHF), polyphenyl ether (PPE), or poly(p-phenylene oxide) (PPO).

Polyesters are also known in the art and are generally prepared by the condensation of a diols, triols and higher functionality polyols and an aliphatic and/or aromatic dicarboxylic acid and include, as none limiting examples, adipic acid, succinic acid, glutaric acid, azelaic acid, sebacic acid, malonic acid, maleic acid, fumaric acid, caprolactone, phthalic acid, isophthalic acid, terephthalic acid, tetrachlorophthalic acid, chlorendic acid and the acid anhydride and acid halides of these acids. Suitable diols, triols and higher functionality polyols and combinations thereof may be, as none limiting examples, ethylene glycol, propylene glycol, diethylene glycol, triethylene glycol, dipropylene glycol, 1,2-cyclopentanediol, 1,2-cyclohexanediol, 1,4-butanediol, neopentyl glycol, 1,6-hexanediol, hydroquinone bis(2-hydroxyethyl)ether, glycerol, 1,2,4-butanetriol, diglycerol, sugars, and other low molecular weight polyols. Other polyesters useful herein is Castor oil and derivatives thereof.

One or more cross linker(s) and/or chain extender(s) may be used in the polyurethane compositions. Suitable cross linker(s) and/or chain extender(s) are known in the art. None limiting examples include ethylene glycol, propylene glycol, ethylenediamine, diethylene glycol, triethylene glycol, dipropylene glycol, diethylenetriamine, 1,3-butanediol, 1,4-butanediol, neopentyl glycol, 1,6hexanediol, toluenediamine, hydroquinone bis(2-hydroxyethyl)ether, diphenylmethanediamine, glycerol, trimethylol propane, diethylenetriamine, triethanolamine, 1,2,4-butanetriol, pentaerythritol, diglycerol, sugars, and other low molecular weight polyols.

One or more flame retardant(s) may also be used. Suitable flame retardant(s) are known in the art. None limiting examples include trichlorpropylphosphate, dimethylmethylphosphonate, diethylethylphosphonate, dimethylphenylpiperazinium, triethylphosphate, and other phosphonates, phosphates, and halogenated polyols.

One or more catalyst(s) may also be used. Suitable tertiary amine catalyst(s) and/or organometallic catalyst(s) and/or carboxylate urethane catalyst(s) are known in the art. None limiting examples include triethylenediamine, N,N-dimethylcyclohexylamine, tetramethylhexanediamine, tris-(3-dimethylamino)-propylamine, dibutyltindilaurat, dimethylethanolamine, dibutylbis-(dodecylthio)-stannan, potassium-2-ethylhexanoat, dibutyltinlaureate, 1,3,5-tris-(dimethylaminopropyl)-hexahydrotriazin, dimethylaminoethanol, diethylaminoethanol, pentamehtyldiethylenetriamine, methylmorpholine, ethylmorpholine, quaternary ammonium salts, 1,2-dimethylimidazole.

One or more surfactant(s) may also be used. A number of surfactants are known in the art for stabilizing and/or controlling the foam properties in polyurethane productions. None limiting examples include cell stabilizers, wetting agents, viscosity reducing agents, thixotropic agents, air release agents.

One or more physical and/or chemical blowing agent(s) known in the art may also be used. Non-limiting examples include water, formic acid, dimethoxymethane, iso-pentane, n-pentane, cyclopentane, HCFC (hydrochlorofluorocarbon) compounds, HFC (hydrofluorocarbon) compounds and mixtures thereof.

Suitable polyisocyanate components include the known aliphatic, cycloaliphatic and aromatic di- and/or polyisocyanates. Examples are 1,4-butylenediisocyanate, 1,5-pentanediisocyanate, 1,6-hexamethylenediisocyanate (HDI), isophorondiisocyanate (IPDI), 2,2,4- and/or 2,4,4-trimethylhexamethylenediisocyanate, bis(4,4′-isocyanatocyclohexyl)methane or mixtures with the other isomers, 1,4-cyclohexylenediisocyanate, 1,4-phenylenediisocyanate, 2,4- and/or 2,6-toluylenediisocyanate (TDI), 1,5-naphthylenediisocyanate, 2,2′- and/or 2,4′- and/or 4,4′-diphenylmethanediisocyanate (MDI) and/or higher homologues (pMDI), 1,3- and/or 1,4-bis-(2-isocyanato-prop-2-yl)-benzene (TMXDI) and 1,3-bis-(isocyanatomethyl)benzene (XDI).

A preferred polyisocyanate is MDI and especially mixtures of MDI and polymeric MDI. The mixtures of MDI and pMDI preferably have a monomer content between 40 weight-% and 100 weight-%. The NCO content of the polyisocyanate employed should be above 25 weight-%, preferably above 31,4 weight-%. It is also preferred that the MDI employed has a combined content of the 2,2′ isomer and 2,4′ isomer of at least 3 weight-%, preferably at least 20 weight-% and more preferred at least 40 weight-%.

The polyurethane reaction mixture may also comprise known additives such as fillers. Preferred fillers are carbon nanotubes, barium sulfate, titanium dioxide, short glass fibers or natural fibrous or platelet-formed minerals such as wollastonite or muskowite.

In a further embodiment of the composite profile according to the invention the foam core 1 comprises a polyurethane foam obtainable by the reaction of a mixture comprising:

Component A: a polyol formulation, comprising:
(a) One or more polyether polyol(s) and/or one or more polyester polyol(s) and/or polyamines with hydroxyl number(s) from between 12 and 1200 mg KOH/g, and molecular weight(s) from between 60 and 7000 g/mol, and functionality from between 2 and 8, preferably with hydroxyl number(s) from between 150 and 600 mg KOH/g, and molecular weight(s) from between 300 and 1200 g/mol, and functionality from between 2 and 4;
(b) None, one or more cross linker(s) and/or chain extender(s) with hydroxyl number(s) from between 500 and 2000 mg KOH/g, and molecular weight(s) from between 60 and 400 g/mol, and functionality from between 2 and 8, preferably with hydroxyl number(s) from between 1000 and 2000 mg KOH/g, and molecular weight(s) from between 60 and 160 g/mol, and functionality from between 2 and 3;
(c) One or more amine and/or organometallic and/or metallic catalyst(s), preferably organic tertiary amine(s);
(d) None, one or more flame retardant(s) which may be halogenated, preferably a halogenated phosphate/phosphonate;
(e) One or more surfactants, preferably at least one cell stabilizer;
(f) One or more chemical and/or physical blowing agents, preferably water, and/or carboxylic acid(s), and/or hydrocarbons, and/or halogenated hydrocarbons, more preferably water and/or formic acid add/or hydrocarbons;
   and

Component B: an isocyanate, comprising:
(a) Diphenylmethane diisocyanate and/or polymeric diphenylmethane diisocyanate with a preferred monomer content from between 40-100 wt-% and with an NCO-content of 25 wt-% to 35 wt-%, preferably about 30 wt-%, more preferably about 31.4 wt-%; and
(b) Preferably, a MDI with at least a 3 wt-% content of 2,2′-diphenylmethane diisocyanate and 2,4′-diphenylmethane diisocyanate, preferably at least 20 wt-%, more preferably at least 40 wt -%.

In a further embodiment of the composite profile according to the invention the reinforcement fabric 4 comprises glass fibers, carbon fibers and/or aramid fibers.

In a further embodiment of the composite profile according to the invention the foam core 1 is bonded to the reinforcement fabric 4 without the use of an additional adhesive. This may be achieved by contacting a not completely cured foam which still possesses a residual tackiness to the reinforcement fabric 4 and then allowing the foam to cure further. At the same time the foam should have such a high viscosity that no penetration into the fabric 4 takes place. An advantage of this embodiment is that in a subsequent resin infusion during the course of using the profile as a distance element in hollow bodies the resin can contact the fabric 4 as well as the foam core 1.

In a further embodiment of the composite profile according to the invention the reinforcement fabric 4 is in a one-part form. Advantages of this include a higher mechanical stability of the edges of the profile. Preferably the reinforcement fabric 4 is not broken, but at the most bent into shape without breaking or creasing the fibers of the fabric. It is also easy to accomplish the covering of two adjacent sides of the foam core 1 with a fabric 4.

In a further embodiment of the composite profile according to the invention the reinforcement fabric 4 is a prepreg.

In a further embodiment of the composite profile according to the invention the profile comprises a plurality of foam cores 1 in contact with the reinforcement fabric 4. This is depicted in FIG. 2 which shows such a plurality of foam cores 1 and a single, one-piece reinforcement fabric 4. In order to elucidate the method according to the invention (see below) an upwardly open cavity 1′ is also depicted. It should be noted that this cavity 1′ should also be filled with foam 1 in the finished composite profile.

FIG. 3 shows another embodiment of the composite profile according to the invention. Here the outermost side walls of the reinforcement fabric 4 are in a different angle than the interior side walls. This can be useful if one wishes to minimize a side wall gap inside a hollow body. Independently of this embodiment FIG. 3 also shows that all cavities in the composite profile comprise the foam 1. This can be achieved by using the method according to the invention twice with turning the half-finished profile upside down before the second run.

FIG. 4 schematically shows an execution of the method according to the invention. A transport belt 5 may transport an optional sheet 6. This sheet 6 may be, for example, a (profiled) support material, a packaging material, a separation layer or the like made of paper, plastic, etc. The reinforcement fabric 4 is pulled from another roll and passed through forming device 7 and placed onto transport belt 5 or the optional sheet 6. This is with respect to the first step of the method according to the invention: providing a reinforcement fabric 4, the reinforcement fabric (4) being provided in such a shape as to define at least one upwardly open cavity 1′ (see FIG. 2) adapted to receive a foam and wherein at least two adjacent sides of the cavity are formed by the reinforcement fabric 4.

The upwardly open cavity may be easily accomplished by bending or folding the reinforcement fabric 4 in the forming device 7. If a triangular cross-section is desired, the fabric could be folded into a “V” shape and the open side of the “V” could receive the foam. It is also apparent that the cavity has two adjacent sides formed by the fabric 4.

It should be noted that particularly with regard to definitions, materials and properties of the foam core 1 and the reinforcement fabric 4 what has been said in connection with the profile according to the invention also may be applied to the method according to the invention.

A subsequent step in the method according to the invention comprises providing a solid or spreadable foam 1 into the at least one cavity 1′ of the reinforcement fabric 4, wherein the foam 1 does not or not completely penetrate into the reinforcement fabric 4. In the case of a solid foam an appropriately cut foam profile would be placed into the cavity. If the foam is spreadable then the foam would be applied with a suitable application device 8 which could be a foaming system. This is advantageously followed by a rapid curing of the foam. As already mentioned it is possible to use the residual tackiness of the foam in order to create an adhesive bonding between the fabric 4 and the foam 1.

Suitable support means such as (fixed) side walls may be employed in order to preserve the cavity 1′ until or beyond the providing of the foam 1.

An optional covering layer 9 may be applied to the profile obtained. Furthermore, roll and belt system 10 can exert downward pressure to ensure a uniform appearance of the profile. Not shown in FIG. 4 is an optional cutting of the profile to a desired length.

In one embodiment of the method according to the invention the reinforcement fabric 4 is a woven textile or an at least bidirectionally oriented non-woven textile. It is possible that the reinforcement fabric 4 comprises more than one fiber layer. Then the fiber orientation may also vary from layer to layer. For example, multidirectional fiber layers are contemplated in which unidirectional or woven layers are stacked upon each other. It is preferred that the reinforcement fabric 4 is a biaxial non-woven fabric with at least a portion of the fibers oriented in an angle of 40° to 50° with respect to the longitudinal axis of the profile.

In another embodiment of the method according to the invention, in step (I) the reinforcement fabric 4 is provided in such a shape as to define a plurality of upwardly open cavities 1′ adapted to receive respective foams and in step (II) foam is provided into each cavity 1′. For example, the fabric 4 may be provided in a “W” or a “WW” shape. By this procedure composite profiles such as those depicted in FIG. 2 and FIG. 3 may be obtained.

In another embodiment of the method according to the invention step (II) comprises introducing a frothing and/or thixotropic foam 1 into the at least one cavity 1′ of the reinforcement fabric 4. The frothing foam can be distributed from a mixing head, for example in the case of a polyurethane foam system.

In another embodiment of the method according to the invention the foam 1 is a spreadable foam obtained from a reaction mixture and is provided into the at least one cavity 1′ of the reinforcement fabric 4 after the cream time of the reaction mixture. Preferably the reaction mixture is a polyurethane reaction mixture such as one that has been described above. The time delay between mixing of the components and the introduction of the foam into the cavity or cavities may be achieved by an appropriately long nozzle after the mixing head for the reaction mixture. Alternatively or in addition to this, a fast reacting (polyurethane) system may be employed.

It is also possible to introduce the foam after the rise time of the reaction mixture. However, it is greatly preferred that the foam has not yet reached the tack-free time.

The cream time is the time which elapses from the start of mixing of the reactants to the visible start of foaming of the mix. In many cases this can be seen clearly by a color change. The string or fiber time is the transition of the reaction mix from the liquid to the solid state. It roughly corresponds to the gel point. When this point in time is reached the reaction is about 50% complete. The fiber time is measured by, for example, a wooden rod being repeatedly immersed in and removed from the already well expanding reaction mix, and it is determined when the rod draws fibers. Time measurement begins with mixing. After fiber time, the speed at which the foam rises slows down.

The time from the start of mixing till the end of the optically perceptible rise is called the rise time. The surface of the foam is still tacky when the rise process is complete. By repeatedly testing the foam surface with a wooden rod, the moment of freedom from tack is determined The time elapsing from the start of mixing to the moment when the surface is no longer tacky is called tack-free time.

In another embodiment of the method according to the invention the at least one open cavity 1′ in the reinforcement fabric 4 is brought or held into the intended shape by means of hook and loop fasteners, guide rails, suction or pressure before, during and/or after the providing of the foam 1. This allows for a stabilization of the fabric 4 and thus of the at least one cavity F.

In another embodiment of the method according to the invention the foam 1 comprises a polyurethane foam (PU foam), an epoxy resin foam (EP foam), a polyester resin foam (in particular an unsaturated polyester resin foam; UP foam), an expanded polystyrene foam (EPS foam) and/or an expanded polypropylene foam (EPP foam). Other expanded polyolefin foams or further thermoplastic or duroplastic foams are also possible.

In another embodiment of the method according to the invention the reinforcement fabric 4 comprises glass fibers, carbon fibers and/or aramid fibers.

In another embodiment of the method according to the invention the foam 1 is bonded to the reinforcement fabric 4 without the use of an additional adhesive. This may be achieved, for example, by using a still tacky foam when filling the at least one cavity 1′.

In another embodiment of the method according to the invention the reinforcement fabric 4 is in a one-part form.

In another embodiment of the composite profile according to the invention the reinforcement fabric 4 is a paper fabric and an additional reinforcement fabric 11 is at least partially in contact with said reinforcement fabric 4. This is shown in FIGS. 5 and 6. Preferably, the additional reinforcement fabric 11 comprises glass fibers, carbon fibers and/or aramid fibers.

It is also preferred that said paper fabric comprises holes 12 as depicted by way of example in FIG. 6. These holes allow the application of vacuum so that resin may impregnate the additional reinforcement fabric 11.

In another embodiment of the method according to the invention at least one section of the reinforcement fabric 4 is not part of the cavity 1′ and said section is at least partially contacted by a removable masking means 14, 14′. Referring to FIG. 7, the reinforcement fabric 4 is shaped by a mold 13 such as to define an upwardly open cavity 1′. A removable masking means 14 such as a masking tape is placed onto the elevated sections of the fabric 4 which do not constitute the cavity 1′. Using such a masking means 14 prevents selected portions of the reinforcement fabric to be contacted by the foam which is to be filled into the cavity 1′

It is possible to not only place a masking means 14 onto the side of the fabric 4 which is opposed to the mold 13, but also to place a masking means 14′ onto the side of the fabric 4 which is adjacent to the mold.

1. A composite profile, comprising at least one of:
a foam core with opposing frontal faces and a plurality of side faces; and
a reinforcement fabric which is at least partially in direct contact with at least two adjacent side faces;
wherein
the reinforcement fabric is a woven textile or an at least bidirectionally oriented non-woven textile;
the foam core does not or not completely penetrate into the reinforcement fabric; and
at least on one side face of the composite profile the foam core is exposed.

2. The composite profile according to claim 1, wherein the foam core comprises a polyurethane foam, an epoxy resin foam, a polyester resin foam, an expanded polystyrene foam and/or an expanded polypropylene foam.

3. The composite profile according to claim 1, wherein the foam core comprises a polyurethane foam obtainable by reaction of a mixture comprising:
Component A: a polyol formulation, comprising:
(a) One or more polyether polyol(s) and/or one or more polyester polyol(s) and/or polyamines with hydroxyl number(s) from 12 to 1200 mg KOH/g, and molecular weight(s) from 60 to 7000 g/mol, and functionality from between 2 to 8;
(b) None, one or more cross linker(s) and/or chain extender(s) with hydroxyl number(s) from between 500 to 2000 mg KOH/g, and molecular weight(s) from between 60 to 400 g/mol, and functionality from between 2 to 8;
(c) One or more amine and/or organometallic and/or metallic catalyst(s);
(d) None, one or more flame retardant(s) which may be halogenated;
(e) One or more surfactants;
(f) One or more chemical and/or physical blowing agents;
and
Component B: an isocyanate, comprising:
(a) Diphenylmethane diisocyanate and/or polymeric diphenylmethane diisocyanate with an optional monomer content 40-100 wt-% and with an NCO-content of 25 wt-% to 35 wt-%.

4. The composite profile according to claim 1, wherein the reinforcement fabric comprises glass fibers, carbon fibers and/or aramid fibers.

5. The composite profile according to claim 1, wherein the foam core is bonded to the reinforcement fabric without use of an additional adhesive.

6. The composite profile according to claim 1, wherein the profile comprises a plurality of foam cores in contact with the reinforcement fabric.

7. The composite profile according to claim 1, wherein the reinforcement fabric is a paper fabric and an additional reinforcement fabric is at least partially in contact with said reinforcement fabric.

8. A method of manufacturing a composite profile according to claim 1, comprising the steps of:
(I) providing a reinforcement fabric, the reinforcement fabric being provided in such a shape as to define at least one upwardly open cavity adapted to receive a foam and wherein at least two adjacent sides of the cavity are formed by the reinforcement fabric; and
(II) providing a solid or spreadable foam into the at least one cavity of the reinforcement fabric, wherein the foam does not or not completely penetrate into the reinforcement fabric.

9. The method according to claim 8, wherein the reinforcement fabric is a woven textile or an at least bidirectionally oriented non-woven textile.

10. The method according to claim 8, wherein in (I) the reinforcement fabric is provided in such a shape as to define a plurality of upwardly open cavities adapted to receive respective foams and in (II) foam is provided into each cavity.

11. The method according to claim 8, wherein (II) comprises introducing a frothing and/or thixotropic foam into the at least one cavity of the reinforcement fabric.

12. The method according to claim 8, wherein the foam is a spreadable foam obtained from a reaction mixture and is provided into the at least one cavity of the reinforcement fabric after the cream time of the reaction mixture.

13. The method according to claim 8, wherein the foam comprises a polyurethane foam, an epoxy resin foam, a polyester resin foam, an expanded polystyrene foam and/or an expanded polypropylene foam.

14. The method according to claim 8, wherein the reinforcement fabric comprises glass fibers, carbon fibers and/or aramid fibers.

15. The method according to claim 8, wherein the foam is bonded to the reinforcement fabric without use of an additional adhesive.

16. The method according to claim 8, wherein the reinforcement fabric is in a one-part form.

17. The method according to claim 8, wherein at least one section of the reinforcement fabric is not part of the cavity and said section is at least partially contacted by removable masking.
